(19) United States
(12) Patent Application Publication
(10) Pub. No.: US 2023/0222105 A1
(43) Pub. Date: Jul. 13, 2023

(54) Upgrading Database Schemas For Multi-Tenant Systems

(71) Applicant: SAP SE, Walldorf (DE)

(72) Inventors: Arjun Shashikumar Kedlaya, Bengaluru (IN); Ramana Kumar Rajaraman, Bengaluru (IN)

(21) Appl. No.: 17/573,505

(22) Filed: Jan. 11, 2022

(51) Int. Cl. G06F 16/21

(52) U.S. Cl. CPC G06F 16/213

(57) ABSTRACT

Some embodiments provide a non-transitory machine-readable medium that stores a program. The program determines a set of data associated with a set of database schemas. The program further compares a first schema definition configured for a first application and a second schema definition configured for a second application. Based on the comparison, the program also generates a set of database commands for upgrading the set of schemas from the first schema definition to the second schema definition. Based on the set of commands and the set of data, the program further upgrades the set of database schemas from the first schema definition to the second schema definition.

### BACKGROUND

Multi-tenant computing systems are configured to serve multiple different tenants. In general, the resources of such computing systems are shared among the tenants. Examples of such resources includes software applications, processing power, data storage, memory, etc. Each tenant served by a multi-tenant computing system typically has its own data, which is isolated from the data of other tenants. There are many ways to manage data in a multi-tenant computing system. For example, data associated with each tenant can be stored together in a tables of a database. Different unique identifiers assigned to different tenants may be employed to identify the tenant to which data belongs. Another way to manage data for tenants is to create a separate set of tables for each tenant in one or more databases. Under this approach, data associated with each tenant are stored in separate sets of tables but the multiple sets of tables for multiple tenants can be stored in the same database. In yet another example, data associated with each tenant are stored in separate databases.

### SUMMARY

In some embodiments, a non-transitory machine-readable medium stores a program executable by at least one processing unit of a device. The program determines a set of data associated with a set of database schemas. The program further compares a first schema definition configured for a first application and a second schema definition configured for a second application. Based on the comparison, the program also generates a set of database commands for upgrading the set of schemas from the first schema definition to the second schema definition. Based on the set of commands and the set of data, the program further upgrades the set of database schemas from the first schema definition to the second schema definition.

In some embodiments, comparing the first schema definition configured for the first application and the second schema definition configured for the second application may include determining a set of differences between the first schema definition and the second schema definition. Each difference in the set of differences may have a defined type. Generating the set of database commands may include, for each difference in the set of differences, generating a defined type of database command associated with the defined type of the difference.

In some embodiments, upgrading the set of database schemas from the first schema definition to the second schema definition may include, for each database schema in the set of database schemas, instantiating a worker thread and instructing the worker thread to use the set of commands to upgrade the schema from the first schema definition to the second schema definition. Each data in the set of data may include login credentials for a database schema in the set of database schemas, a schema identifier associated with the database schema, and a database identifier associated with a database in which the database schema is stored. Upgrading the set of database schemas from the first schema definition to the second schema definition may further include, for each database schema in the set of database schemas, identifying the login credentials associated with the database schema based on the schema identifiers, identifying the database associated with the database schema based on the schema identifiers and the database identifiers, and instructing the worker thread to use the login credentials associated with database schema to access the database schema stored in the database having the identified database identifier. Instantiating the worker threads and instructing the worker threads to use the set of commands to upgrade the schema from the first schema definition to the second schema definition may be performed in parallel. The program may receive a message indicating the upgrade of a particular database schema in the set of database schemas failed and, in response to the message, retry to upgrade the particular database schema from the first schema definition to the second schema definition.

In some embodiments, a method determines a set of data associated with a set of database schemas. The method further compares a first schema definition configured for a first application and a second schema definition configured for a second application. Based on the comparison, the method also generates a set of database commands for upgrading the set of schemas from the first schema definition to the second schema definition. Based on the set of commands and the set of data, the method further upgrades the set of database schemas from the first schema definition to the second schema definition.

In some embodiments, comparing the first schema definition configured for the first application and the second schema definition configured for the second application may include determining a set of differences between the first schema definition and the second schema definition. Each difference in the set of differences may have a defined type. Generating the set of database commands may include, for each difference in the set of differences, generating a defined type of database command associated with the defined type of the difference.

In some embodiments, upgrading the set of database schemas from the first schema definition to the second schema definition may include, for each database schema in the set of database schemas, instantiating a worker thread and instructing the worker thread to use the set of commands to upgrade the schema from the first schema definition to the second schema definition. Each data in the set of data may include login credentials for a database schema in the set of database schemas, a schema identifier associated with the database schema, and a database identifier associated with a database in which the database schema is stored. Upgrading the set of database schemas from the first schema definition to the second schema definition further include, for each database schema in the set of database schemas, identifying the login credentials associated with the database schema based on the schema identifiers, identifying the database associated with the database schema based on the schema identifiers and the database identifiers, and instructing the worker thread to use the login credentials associated with database schema to access the database schema stored in the database having the identified database identifier. Instantiating the worker threads and instructing the worker threads to use the set of commands to upgrade the schema from the first schema definition to the second schema definition may be performed in parallel. The method may further receive a message indicating the upgrade of a particular database schema in the set of database schemas failed and, in response to the message, retry to upgrade the particular database schema from the first schema definition to the second schema definition.

In some embodiments, a system includes a set of processing units and a non-transitory machine-readable medium that stores instructions. The instructions cause at least one processing unit to determine a set of data associated with a set of database schemas. The instructions further cause the at least one processing unit to compare a first schema definition configured for a first application and a second schema definition configured for a second application. Based on the comparison, the instructions also cause the at least one processing unit to generate a set of database commands for upgrading the set of schemas from the first schema definition to the second schema definition. Based on the set of commands and the set of data, the instructions further cause the at least one processing unit to upgrade the set of database schemas from the first schema definition to the second schema definition.

In some embodiments, comparing the first schema definition configured for the first application and the second schema definition configured for the second application may include determining a set of differences between the first schema definition and the second schema definition. Each difference in the set of differences may have a defined type. Generating the set of database commands may include, for each difference in the set of differences, generating a defined type of database command associated with the defined type of the difference.

In some embodiments, upgrading the set of database schemas from the first schema definition to the second schema definition may include, for each database schema in the set of database schemas, instantiating a worker thread and instructing the worker thread to use the set of commands to upgrade the schema from the first schema definition to the second schema definition. Each data in the set of data may include login credentials for a database schema in the set of database schemas, a schema identifier associated with the database schema, and a database identifier associated with a database in which the database schema is stored. Upgrading the set of database schemas from the first schema definition to the second schema definition may further include, for each database schema in the set of database schemas, identifying the login credentials associated with the database schema based on the schema identifiers, identifying the database associated with the database schema based on the schema identifiers and the database identifiers, and instructing the worker thread to use the login credentials associated with database schema to access the database schema stored in the database having the identified database identifier. Instantiating the worker threads and instructing the worker threads to use the set of commands to upgrade the schema from the first schema definition to the second schema definition may be performed in parallel.

The following detailed description and accompanying drawings provide a better understanding of the nature and advantages of various embodiments of the present disclosure.

### BRIEF DESCRIPTION OF THE DRAWINGS

FIG. 1 illustrates a computing system for upgrading database schemas according to some embodiments.

FIG. 2 illustrates an example schema definition according to some embodiments.

FIG. 3 illustrates an example table definition according to some embodiments.

FIG. 4 illustrates an example schema definition for a current application according to some embodiments.

FIG. 5 illustrates an example schema definition for an upgraded application according to some embodiments.

FIG. 6 illustrates a process for upgrading database schemas according to some embodiments.

FIG. 7 illustrates an exemplary computer system, in which various embodiments may be implemented.

FIG. 8 illustrates an exemplary system, in which various embodiments may be implemented.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for upgrading database schemas for multi-tenant systems. In some embodiments, a computing system includes an application and one or more databases. Each database includes one or more database schemas that are each configured for a different tenant that uses the computing system (e.g., via a client device). A schema definition, which defines a set of tables and the relationships between those tables, is configured for the application. Each of the database schemas are created based on the schema definition. When the application is upgraded, a different schema definition may be configured for the upgraded application. To upgrade the database schemas stored in the databases, the computing system determines the differences between the schema definition of the original application and the schema definition of the upgraded application. Based on the differences, the computing system generates a set of database commands to effectuate the changes between the two schema definitions. Then, the computing system concurrently instantiates a different worker thread for each of the different database schemas stored in the databases and instructs the worker threads to upgrade the respective database schemas using the generated set of commands.

The techniques described in the present application provide a number of benefits and advantages over conventional methods for upgrading database schemas. For instance, performing the upgrades to multiple database schemas in parallel reduces the amount of time it takes to upgrade all the database schemas. Conventional ways for upgrading database schemas may perform these upgrades sequentially.

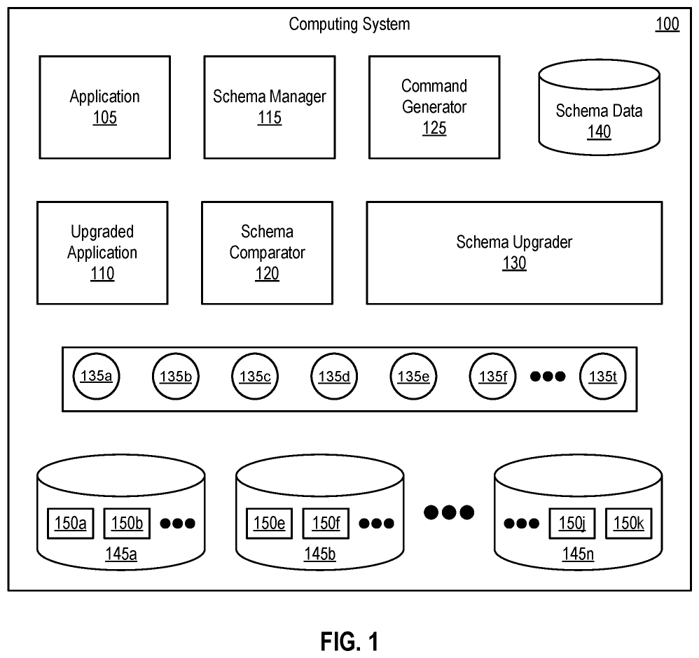

FIG. 1 illustrates a computing system 100 for upgrading database schemas according to some embodiments. As shown, computing system 100 includes application 105, upgraded application 110, schema generator 115, schema comparator 120, command generator 125, schema upgrader 130, worker threads 135a-t, schema data storage 140, and databases 145a-n. Schema data storage 140 is configured to store data associated with database schemas. For example, schema data storage 140 can store login credentials (e.g., a login identifier (ID) and a password) for accessing a database schema 150, a mapping between the login credentials and a unique ID for identifying the database schema, and a mapping between the unique ID of the database schema 150 and a unique ID for identifying the database 145 in which the database schema 150 is stored. Each of the databases 145a-n has a unique ID associated with it and stores a set of database schemas 150. Each database schema 150 has a unique ID associated with it and includes a set of tables that are related to each other in the manner defined by a schema definition. In some embodiments, schema data storage 140 and databases 145a-n are implemented in a single physical storage while, in other embodiments, schema data storage 140 and databases 145a-n may be implemented across several physical storages. While FIG. 1 shows schema data storage 140 and databases 145a-n as part of computing system 100, one of ordinary skill in the art will appreciate that schema data storage 140 and databases 145a-n may be external to computing system 100 in some embodiments.

Application 105 is a software application operating on computing system 100 configured to manage data for tenants using computing system 100 (e.g., via client devices). For instance, application 105 may receive a request for data associated with a particular tenant (e.g., from a client device, another application, a service, etc.). In response to the request, application 105 accesses the database 145 storing the schema 150 configured for the particular tenant to retrieve the requested data and then sends the retrieved data to the requestor. Application 105 can receive similar requests to add, modify, and/or delete data associated with the particular tenant and process such requests accordingly. In some embodiments, each of the schemas 150 that application 105 uses to manage data for tenants includes a set of tables related to each other in a manner defined by a schema definition configured for application 105. In some such embodiments, application 105 includes the schema definition. In some embodiments, a schema definition specifies a set of tables and a set of relationships between tables in the set of tables. In some cases, application 105 may receive from schema comparator 120 a request for its schema definition. In response, application 105 sends schema comparator 120 the schema definition that application 105 is using.

Upgraded application 110 is a software application operating on computing system 100 that is an upgraded version of application 105. Upgraded application 110 has the same or similar functionalities as application 105. In some embodiments, upgraded application 110 still uses schemas 150 to manage data for tenants. However, in some instances, a schema definition configured for upgraded application 110 is different than the schema definition configured for application 105 (e.g., it has additional and/or different tables, some tables have additional and/or different table attributes, etc.). In some embodiments, this schema definition is included in upgraded application 110. In such instances, schemas 150 would need to be upgraded (e.g., modified) to be consistent with the schema definition configured for upgraded application 110. In some cases, upgraded application 110 can receive from schema comparator 120 a request for its schema definition. In response to the request, upgraded application 110 sends schema comparator 120 the schema definition that upgraded application 110 is using.

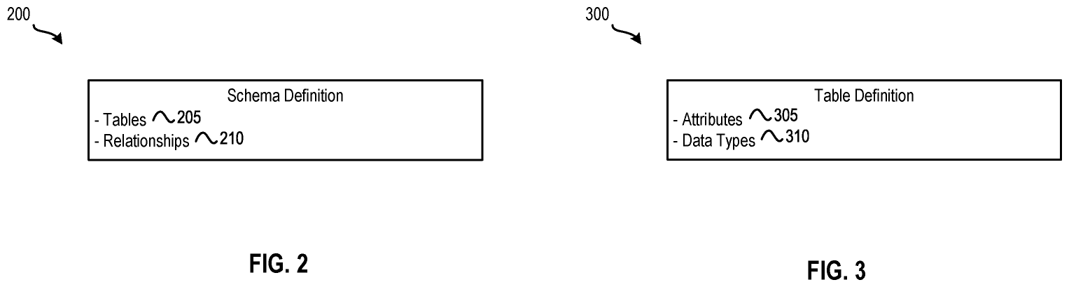

FIG. 2 illustrates an example schema definition 200 according to some embodiments. In some embodiments, schema definition 200 can be used to implement the schema definitions configured for application 105 and upgraded application 110. As illustrated, schema definition 200 specifies a set of tables 205 and a set of relationships 210. FIG. 3 illustrates an example table definition 300 according to some embodiments. In some embodiments, table definition 300 is used to define each table in set of tables 205. As depicted in FIG. 3, table definition 300 specifies a set of attributes 305 and a set of data types 310. Each attribute in the set of attributes 305 can be a name of the attribute. Each data type in the set of data types 310 may be a data type (e.g., an integer, a string, a Boolean, a floating point number, etc.) of a corresponding attribute in the set of attributes 305. Returning to FIG. 2, each relationship in set of relationships 210 specifies a relationship between two tables in set of tables 205 in terms of a keys (e.g., primary keys, foreign keys, etc.) and/or relationship type (e.g., one-to-one relationship, one-to-many relationship, many-to-many relationship, etc.).

Returning to FIG. 1, schema manager 115 is configured to manage schemas for computing system 100. For example, when schema manager 115 detects that application 105 is being upgraded with upgraded application 110, schema manager 115 accesses schema data storage 140 to retrieve the login credentials for accessing each database schema 150, the mapping between the login credentials and the unique ID associated with database schema 150, and the mapping between the unique ID of the database schema 150 and unique ID associated with the database 145 in which the database schema 150 is stored. Next, schema manager 115 sends schema comparator 120 a request to compare schema definitions of application 105 and upgraded application 110. Upon receiving a set of commands from command generator 125, schema manager 115 sends schema upgrader 130 the login credentials, the mappings, the set of commands, and a request to upgrade schemas 150a-k.

Schema comparator 120 is responsible for comparing schema definitions. For instance, schema comparator 120 can receive from schema manager 115 a request to compare schema definitions of application 105 and upgraded application 110. In response to the request, schema comparator 120 sends application 105 a request for the schema definition that is configured for application 105. In addition, schema comparator 120 sends upgraded application 110 a request for the schema definition that is configured for upgraded application 110. Once schema comparator 120 receives the schema definitions from application 105 and upgraded application 110, schema comparator 120 compares the two schema definitions to determine any differences between the two. In some embodiments, schema comparator 120 determines the differences in terms of a defined number of different types of differences. For instance, in some such embodiments, schema comparator 120 determines differences between two schema definitions in terms of the following: additions/modifications to table attributes, deletions of table attributes, additions of tables, and deletions of tables. After schema comparator 120 determines these differences, schema comparator 120 sends them to command generator 125.

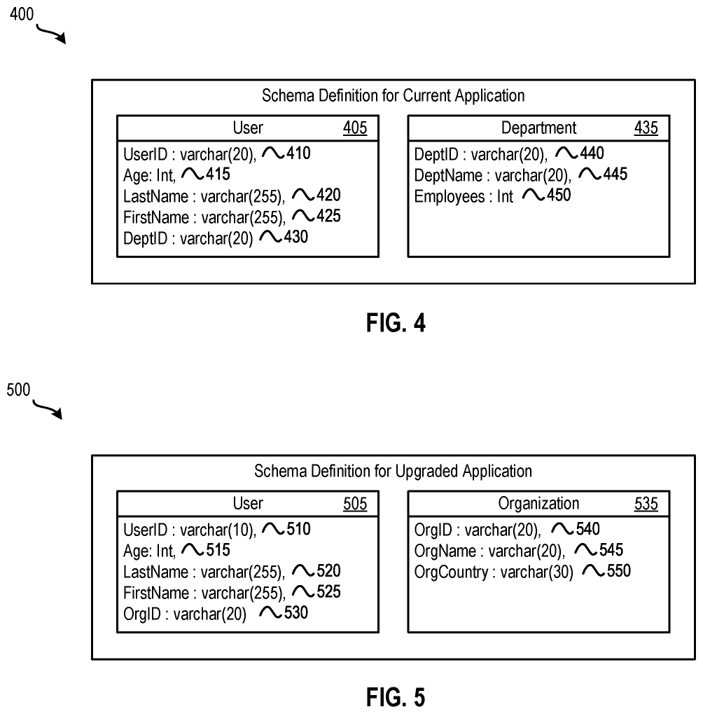

An example of determining differences between two schema definitions will now be described by reference to FIGS. 4 and 5. FIG. 4 illustrates an example schema definition 400 for a current application according to some embodiments. As shown, schema definition 400 specifies table 405 and 435. Table 405 specifies attributes 410-430. Attribute 410 is a 20 character string for identifying a user. Attribute 415 is an integer representing an age of the user. Attributes 420 and 425 are each a 255 character string representing a last name of the user and a first name of the user, respectively. Attribute 430 is a 20 character string for identifying a department associated with the user. Table 435 specifies attributes 440-450. Attribute 440 is a 20 character string for identifying a department. Attribute 445 is a 20 character string representing a name of the department. Attribute 450 is an integer representing a number of employees in the department.

FIG. 5 illustrates an example schema definition 500 for an upgraded application according to some embodiments. As depicted in FIG. 5, schema definition 500 specifies tables 505 and 535. Attribute 510 is a 10 character string for identifying a user. Attribute 515 is an integer representing an age of the user. Attributes 520 and 525 are each a 255 character string representing a last name of the user and a first name of the user, respectively. Attribute 530 is a 20 character string for identifying an organization associated with the user. Table 535 specifies attributes 540-550. Attribute 540 is a 20 character string for identifying an organization. Attribute 545 is a 20 character string representing a name of the organization. Attribute 550 is 20 character string representing a country where the organization is located.

For this example, schema definition 400 is the schema definition configured for application 105 and schema definition 500 is the schema definition configured for upgraded application 110. Schema comparator 120 compares schema definition 400 and schema definition 500. In this example, schema comparator 120 categorizes the differences according to the four example types of differences mentioned above. Here, schema comparator 120 determines the additions/modifications to table attributes when upgrading from schema definition 400 to schema definition 500 include a modification of attribute 410 to attribute 510 and an addition of attribute 530. Schema comparator 120 determines the deletions of table attributes include a deletion of attribute 430 from table 405. In addition, schema comparator 120 determines the additions of tables include the addition of table 535. Finally, schema comparator 120 determines the deletions of tables include the deletion of table 435. Schema comparator 120 sends these differences to command generator 125 for further processing.

Command generator 125 is configured to generate commands based on differences between schema definitions. For example, command generator 125 may receive from schema comparator 120 a set of differences between schema definitions. As explained above, the differences can be specified in terms of different types of differences. In some embodiments, command generator 125 generates different types of commands for different types of differences between schema definitions. Using the example types of differences described above, command generator 125 can generate ALTER commands for additions/modifications to table attributes. For deletions of table attributes, command generator 125 may generate DELETE commands. If the type of differences are additions of tables, command generator 125 generates CREATE commands Lastly, command generator 1253 may generate DROP commands for deletions of tables. Once command generator 125 generates a set of commands based on the differences between schema definitions, command generator 125 sends them to schema manager 115.

Schema upgrader 130 handles the upgrading of database schemas. For instance, schema upgrader 130 may receive from schema manager 115 login credentials, mappings, a set of commands, and a request to upgrade schemas 150a-k. In response to the request, schema upgrader 130 upgrades schemas 150a-k based on the login credentials, mappings, and set of commands. To upgrade a particular schema 150, schema upgrader 130 instantiates a worker thread 135. Then, schema upgrader 130 determines the unique ID associated with the particular schema 150 and uses the mappings to identify the login credentials associated with the unique ID and the unique ID of the database 145 in which the particular schema 150 is stored. Next, schema upgrader 130 sends the identified login credentials, the unique ID of the identified database, and the set of commands to the instantiated worker thread and instructs the worker thread to upgrade the particular schema 150 using the set of commands In some embodiments, schema upgrader 130 can perform the upgrade in parallel for at least two of the schemas 150a-k. In some embodiments, schema upgrader 130 tries to perform the upgrades to as many schemas 150a-k in parallel as possible. In some cases, schema upgrader 130 may receive from a worker thread 135 a message indicating that an upgrade to a schema 150 failed. In some such cases, schema upgrader 130 retries a defined number of times to upgrade the schema 150 in the same manner explained above.

Worker threads 135a-t are each configured to upgrade schemas 150a-k. For example, once instantiated, a worker thread 135 can receive from schema upgrader 130 login credentials, a unique ID associated with a database 150, a set of commands, and instructions to upgrade a particular schema 150 using the set of commands In response, the worker thread 135 uses the login credentials to access the particular schema 150 stored in the database 150 having the unique ID and executes the set of commands on the particular schema to upgrade it.

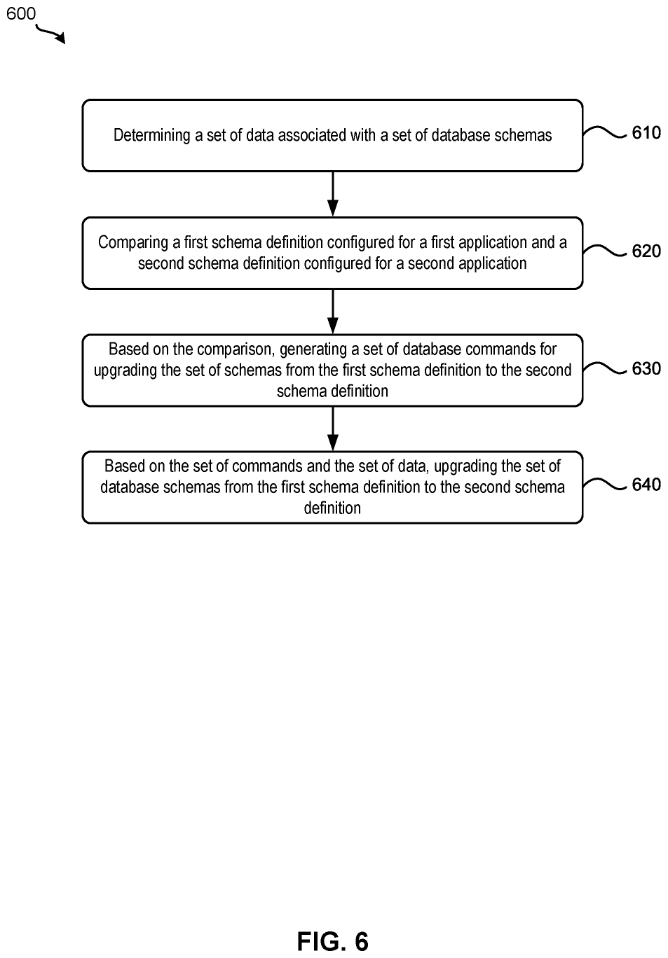

FIG. 6 illustrates a process 600 for upgrading database schemas according to some embodiments. In some embodiments, computing system 100 performs process 600. Process 600 starts by determining, at 610, a set of data associated with a set of database schemas. Referring to FIG. 1 as an example, when schema manager 115 detects that application 105 is being upgraded with upgraded application 110, schema manager 115 can access schema data storage 140 to retrieve the login credentials for accessing each database schema 150, the mapping between the login credentials and the unique ID associated with database schema 150, and the mapping between the unique ID of the database schema 150 and unique ID associated with the database 145 in which the database schema 150 is stored.

Next, process 600 compares, at 620, a first schema definition configured for a first application and a second schema definition configured for a second application. Referring to FIGS. 1, 4, and 5 as an example, schema comparator 120 can send application 105 and upgraded application 110 requests for the schema definition that is configured for application 105 and the schema definition that is configured for upgraded application 110, respectively. Upon receiving the schema definitions from application 105 and upgraded application 110, schema comparator 120 compares schema definitions 400 and 500 to determine any differences between the two.

Based on the comparison, process 600 then generates, at 630, a set of database commands for upgrading the set of schemas from the first schema definition to the second schema definition. Referring to FIG. 1 as an example, command generator 125 may generate a set of commands based on the differences between schema definitions. Finally, based on the set of commands and the set of data, process 600 upgrades, at 640, the set of database schemas from the first schema definition to the second schema definition. Referring to FIG. 1 as an example, schema upgrader 130 can instantiate a worker thread 135 for each database schema 150 and instructs the worker threads 135 to upgrade the database schemas 150 using the set of commands.

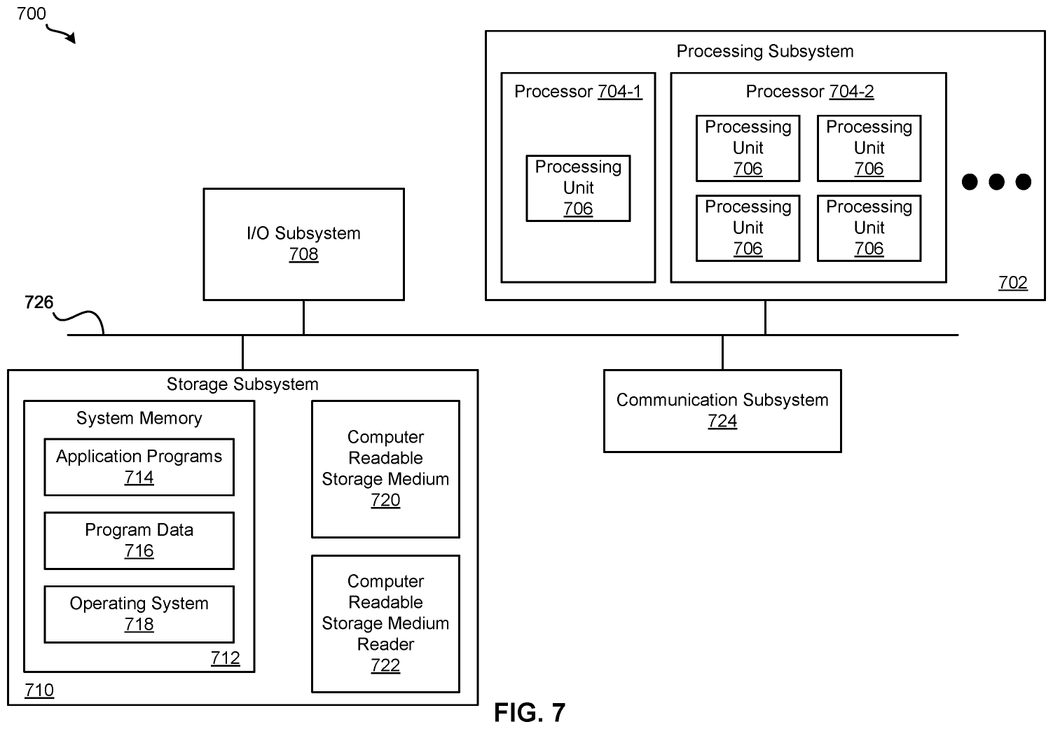

FIG. 7 illustrates an exemplary computer system 700 for implementing various embodiments described above. For example, computer system 700 may be used to implement computing system 100. Computer system 700 may be a desktop computer, a laptop, a server computer, or any other type of computer system or combination thereof. Some or all elements of application 105, upgraded application 110, schema generator 115, schema comparator 120, command generator 125, schema upgrader 130, worker threads 135a-t, or combinations thereof can be included or implemented in computer system 700. In addition, computer system 700 can implement many of the operations, methods, and/or processes described above (e.g., process 600). As shown in FIG. 7, computer system 700 includes processing subsystem 702, which communicates, via bus subsystem 726, with input/output (I/O) subsystem 708, storage subsystem 710 and communication subsystem 724.

Bus subsystem 726 is configured to facilitate communication among the various components and subsystems of computer system 700. While bus subsystem 726 is illustrated in FIG. 7 as a single bus, one of ordinary skill in the art will understand that bus subsystem 726 may be implemented as multiple buses. Bus subsystem 726 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 702, which can be implemented as one or more integrated circuits (e.g., a conventional microprocessor or microcontroller), controls the operation of computer system 700. Processing subsystem 702 may include one or more processors 704. Each processor 704 may include one processing unit 706 (e.g., a single core processor such as processor 704-1) or several processing units 706 (e.g., a multicore processor such as processor 704-2). In some embodiments, processors 704 of processing subsystem 702 may be implemented as independent processors while, in other embodiments, processors 704 of processing subsystem 702 may be implemented as multiple processors integrate into a single chip or multiple chips. Still, in some embodiments, processors 704 of processing subsystem 702 may be implemented as a combination of independent processors and multiple processors integrated into a single chip or multiple chips.

In some embodiments, processing subsystem 702 can execute a variety of programs or processes in response to program code and can maintain multiple concurrently executing programs or processes. At any given time, some or all of the program code to be executed can reside in processing subsystem 702 and/or in storage subsystem 710. Through suitable programming, processing subsystem 702 can provide various functionalities, such as the functionalities described above by reference to process 600.

I/O subsystem 708 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 700 to a user or another device (e.g., a printer).

As illustrated in FIG. 7, storage subsystem 710 includes system memory 712, computer-readable storage medium 720, and computer-readable storage medium reader 722. System memory 712 may be configured to store software in the form of program instructions that are loadable and executable by processing subsystem 702 as well as data generated during the execution of program instructions. In some embodiments, system memory 712 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 712 may include different types of memory, such as static random access memory (SRAM) and/or dynamic random access memory (DRAM). System memory 712 may include a basic input/output system (BIOS), in some embodiments, that is configured to store basic routines to facilitate transferring information between elements within computer system 700 (e.g., during start-up). Such a BIOS may be stored in ROM (e.g., a ROM chip), flash memory, or any other type of memory that may be configured to store the BIOS.

As shown in FIG. 7, system memory 712 includes application programs 714 (e.g., application 105, upgraded application 110, etc.), program data 716, and operating system (OS) 718. OS 718 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 720 may be a non-transitory computer-readable medium configured to store software (e.g., programs, code modules, data constructs, instructions, etc.). Many of the components (e.g., application 105, upgraded application 110, schema generator 115, schema comparator 120, command generator 125, schema upgrader 130, and worker threads 135a-t) and/or processes (e.g., process 600) described above may be implemented as software that when executed by a processor or processing unit (e.g., a processor or processing unit of processing subsystem 702) performs the operations of such components and/or processes. Storage subsystem 710 may also store data used for, or generated during, the execution of the software.

Storage subsystem 710 may also include computer-readable storage medium reader 722 that is configured to communicate with computer-readable storage medium 720. Together and, optionally, in combination with system memory 712, computer-readable storage medium 720 may comprehensively represent remote, local, fixed, and/or removable storage devices plus storage media for temporarily and/or more permanently containing, storing, transmitting, and retrieving computer-readable information.

Computer-readable storage medium 720 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 724 serves as an interface for receiving data from, and transmitting data to, other devices, computer systems, and networks. For example, communication subsystem 724 may allow computer system 700 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 724 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 724 may provide components configured for wired communication (e.g., Ethernet) in addition to or instead of components configured for wireless communication.

One of ordinary skill in the art will realize that the architecture shown in FIG. 7 is only an example architecture of computer system 700, and that computer system 700 may have additional or fewer components than shown, or a different configuration of components. The various components shown in FIG. 7 may be implemented in hardware, software, firmware or any combination thereof, including one or more signal processing and/or application specific integrated circuits.

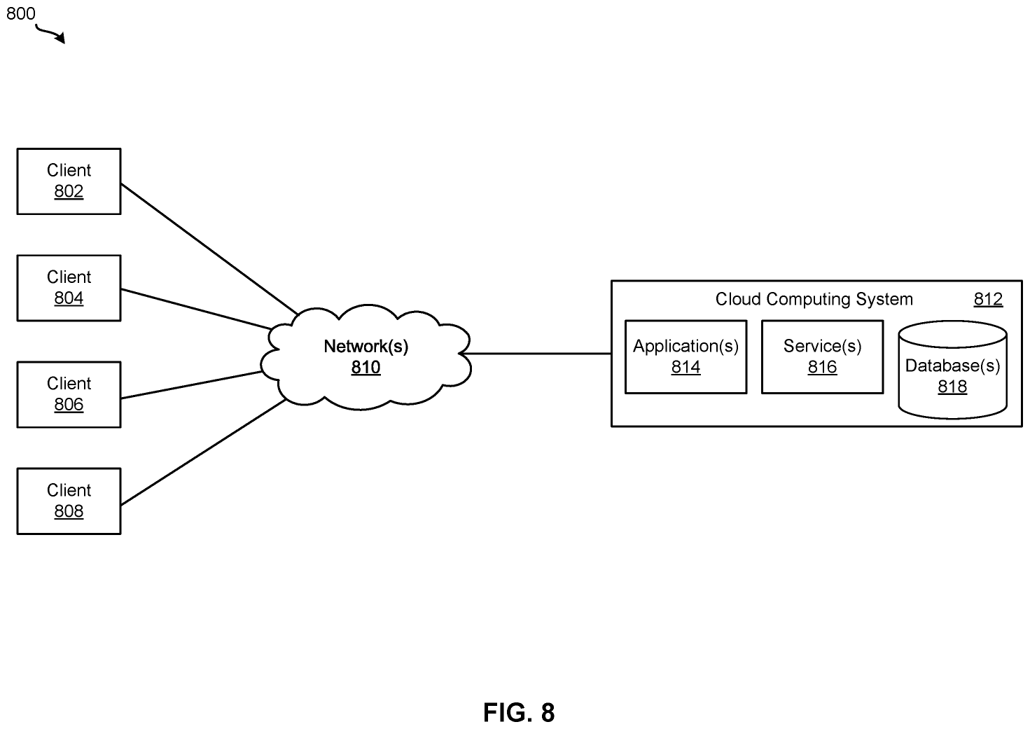

FIG. 8 illustrates an exemplary system 800 for implementing various embodiments described above. For example, cloud computing system 812 may be used to implement computing system 100. As shown, system 800 includes client devices 802-808, one or more networks 810, and cloud computing system 812. Cloud computing system 812 is configured to provide resources and data to client devices 802-808 via networks 810. In some embodiments, cloud computing system 800 provides resources to any number of different users (e.g., customers, tenants, organizations, etc.). Cloud computing system 812 may be implemented by one or more computer systems (e.g., servers), virtual machines operating on a computer system, or a combination thereof.

As shown, cloud computing system 812 includes one or more applications 814, one or more services 816, and one or more databases 818. Cloud computing system 800 may provide applications 814, services 816, and databases 818 to any number of different customers in a self-service, subscription-based, elastically scalable, reliable, highly available, and secure manner.

In some embodiments, cloud computing system 800 may be adapted to automatically provision, manage, and track a customer's subscriptions to services offered by cloud computing system 800. Cloud computing system 800 may provide cloud services via different deployment models. For example, cloud services may be provided under a public cloud model in which cloud computing system 800 is owned by an organization selling cloud services and the cloud services are made available to the general public or different industry enterprises. As another example, cloud services may be provided under a private cloud model in which cloud computing system 800 is operated solely for a single organization and may provide cloud services for one or more entities within the organization. The cloud services may also be provided under a community cloud model in which cloud computing system 800 and the cloud services provided by cloud computing system 800 are shared by several organizations in a related community. The cloud services may also be provided under a hybrid cloud model, which is a combination of two or more of the aforementioned different models.

In some instances, any one of applications 814, services 816, and databases 818 made available to client devices 802-808 via networks 810 from cloud computing system 812 is referred to as a “cloud service.” Typically, servers and systems that make up cloud computing system 812 are different from the on-premises servers and systems of a customer. For example, cloud computing system 812 may host an application and a user of one of client devices 802-808 may order and use the application via networks 810.

Applications 814 may include software applications that are configured to execute on cloud computing system 812 (e.g., a computer system or a virtual machine operating on a computer system) and be accessed, controlled, managed, etc. via client devices 802-808. In some embodiments, applications 814 may include server applications and/or mid-tier applications (e.g., HTTP (hypertext transport protocol) server applications, FTP (file transfer protocol) server applications, CGI (common gateway interface) server applications, JAVA server applications, etc.). Services 816 are software components, modules, application, etc. that are configured to execute on cloud computing system 812 and provide functionalities to client devices 802-808 via networks 810. Services 816 may be web-based services or on-demand cloud services.

Databases 818 are configured to store and/or manage data that is accessed by applications 814, services 816, and/or client devices 802-808. For instance, schema data storage 140 and databases 145a-n may be stored in databases 818. Databases 818 may reside on a non-transitory storage medium local to (and/or resident in) cloud computing system 812, in a storage-area network (SAN), on a non-transitory storage medium local located remotely from cloud computing system 812. In some embodiments, databases 818 may include relational databases that are managed by a relational database management system (RDBMS). Databases 818 may be a column-oriented databases, row-oriented databases, or a combination thereof. In some embodiments, some or all of databases 818 are in-memory databases. That is, in some such embodiments, data for databases 818 are stored and managed in memory (e.g., random access memory (RAM)).

Client devices 802-808 are configured to execute and operate a client application (e.g., a web browser, a proprietary client application, etc.) that communicates with applications 814, services 816, and/or databases 818 via networks 810. This way, client devices 802-808 may access the various functionalities provided by applications 814, services 816, and databases 818 while applications 814, services 816, and databases 818 are operating (e.g., hosted) on cloud computing system 800. Client devices 802-808 may be computer system 700, as described above by reference to FIG. 7. Although system 800 is shown with four client devices, any number of client devices may be supported.

Networks 810 may be any type of network configured to facilitate data communications among client devices 802-808 and cloud computing system 812 using any of a variety of network protocols. Networks 810 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A non-transitory machine-readable medium storing a program executable by at least one processing unit of a device, the program comprising sets of instructions for:
determining a set of data associated with a set of database schemas;
comparing a first schema definition configured for a first application and a second schema definition configured for a second application;
based on the comparison, generating a set of database commands for upgrading the set of schemas from the first schema definition to the second schema definition; and
based on the set of commands and the set of data, upgrading the set of database schemas from the first schema definition to the second schema definition.

2. The non-transitory machine-readable medium of claim 1, wherein comparing the first schema definition configured for the first application and the second schema definition configured for the second application comprises determining a set of differences between the first schema definition and the second schema definition.

3. The non-transitory machine-readable medium of claim 2, wherein each difference in the set of differences has a defined type, wherein generating the set of database commands comprises, for each difference in the set of differences, generating a defined type of database command associated with the defined type of the difference.

4. The non-transitory machine-readable medium of claim 1, wherein upgrading the set of database schemas from the first schema definition to the second schema definition comprises, for each database schema in the set of database schemas, instantiating a worker thread and instructing the worker thread to use the set of commands to upgrade the schema from the first schema definition to the second schema definition.

5. The non-transitory machine-readable medium of claim 4, wherein each data in the set of data comprises login credentials for a database schema in the set of database schemas, a schema identifier associated with the database schema, and a database identifier associated with a database in which the database schema is stored, wherein upgrading the set of database schemas from the first schema definition to the second schema definition further comprises, for each database schema in the set of database schemas, identifying the login credentials associated with the database schema based on the schema identifiers, identifying the database associated with the database schema based on the schema identifiers and the database identifiers, and instructing the worker thread to use the login credentials associated with database schema to access the database schema stored in the database having the identified database identifier.

6. The non-transitory machine-readable medium of claim 4, wherein instantiating the worker threads and instructing the worker threads to use the set of commands to upgrade the schema from the first schema definition to the second schema definition are performed in parallel.

7. The non-transitory machine-readable medium of claim 1, wherein the program further comprises sets of instructions for:
receiving a message indicating the upgrade of a particular database schema in the set of database schemas failed; and
in response to the message, retrying to upgrade the particular database schema from the first schema definition to the second schema definition.

8. A method comprising:
determining a set of data associated with a set of database schemas;
comparing a first schema definition configured for a first application and a second schema definition configured for a second application;
based on the comparison, generating a set of database commands for upgrading the set of schemas from the first schema definition to the second schema definition; and
based on the set of commands and the set of data, upgrading the set of database schemas from the first schema definition to the second schema definition.

9. The method of claim 8, wherein comparing the first schema definition configured for the first application and the second schema definition configured for the second application comprises determining a set of differences between the first schema definition and the second schema definition.

10. The method of claim 9, wherein each difference in the set of differences has a defined type, wherein generating the set of database commands comprises, for each difference in the set of differences, generating a defined type of database command associated with the defined type of the difference.

11. The method of claim 8, wherein upgrading the set of database schemas from the first schema definition to the second schema definition comprises, for each database schema in the set of database schemas, instantiating a worker thread and instructing the worker thread to use the set of commands to upgrade the schema from the first schema definition to the second schema definition.

12. The method of claim 11, wherein each data in the set of data comprises login credentials for a database schema in the set of database schemas, a schema identifier associated with the database schema, and a database identifier associated with a database in which the database schema is stored, wherein upgrading the set of database schemas from the first schema definition to the second schema definition further comprises, for each database schema in the set of database schemas, identifying the login credentials associated with the database schema based on the schema identifiers, identifying the database associated with the database schema based on the schema identifiers and the database identifiers, and instructing the worker thread to use the login credentials associated with database schema to access the database schema stored in the database having the identified database identifier.

13. The method of claim 11, wherein instantiating the worker threads and instructing the worker threads to use the set of commands to upgrade the schema from the first schema definition to the second schema definition are performed in parallel.

14. The method of claim 8 further comprising:
receiving a message indicating the upgrade of a particular database schema in the set of database schemas failed; and
in response to the message, retrying to upgrade the particular database schema from the first schema definition to the second schema definition.

15. A system comprising:
a set of processing units; and
a non-transitory machine-readable medium storing instructions that when executed by at least one processing unit in the set of processing units cause the at least one processing unit to:
determine a set of data associated with a set of database schemas;
compare a first schema definition configured for a first application and a second schema definition configured for a second application;
based on the comparison, generate a set of database commands for upgrading the set of schemas from the first schema definition to the second schema definition; and
based on the set of commands and the set of data, upgrade the set of database schemas from the first schema definition to the second schema definition.

16. The system of claim 15, wherein comparing the first schema definition configured for the first application and the second schema definition configured for the second application comprises determining a set of differences between the first schema definition and the second schema definition.

17. The system of claim 16, wherein each difference in the set of differences has a defined type, wherein generating the set of database commands comprises, for each difference in the set of differences, generating a defined type of database command associated with the defined type of the difference.

18. The system of claim 15, wherein upgrading the set of database schemas from the first schema definition to the second schema definition comprises, for each database schema in the set of database schemas, instantiating a worker thread and instructing the worker thread to use the set of commands to upgrade the schema from the first schema definition to the second schema definition.

19. The system of claim 18, wherein each data in the set of data comprises login credentials for a database schema in the set of database schemas, a schema identifier associated with the database schema, and a database identifier associated with a database in which the database schema is stored, wherein upgrading the set of database schemas from the first schema definition to the second schema definition further comprises, for each database schema in the set of database schemas, identifying the login credentials associated with the database schema based on the schema identifiers, identifying the database associated with the database schema based on the schema identifiers and the database identifiers, and instructing the worker thread to use the login credentials associated with database schema to access the database schema stored in the database having the identified database identifier.

20. The system of claim 18, wherein instantiating the worker threads and instructing the worker threads to use the set of commands to upgrade the schema from the first schema definition to the second schema definition are performed in parallel.
